(19) United States
(12) Patent Application Publication
(10) Pub. No.: US 2012/0273717 A1
(43) Pub. Date: Nov. 1, 2012

(54) LiMPO4-based compositions of matter for cathodes for high-performance Li batteries

(76) Inventors: Li Lu, Singapore (SG); Pengfei Xiao, Singapore (SG); Man On Lai, Singapore (SG); Jiangfeng Ni, Singapore (SG)

(21) Appl. No.: 13/518,885

(22) PCT Filed: Jan. 10, 2011
(86) PCT No.: PCT/SG2011/000010

§ 371 Date: Jun. 24, 2012

Related U.S. Application Data
(60) Provisional application No. 61/335,688, filed on Jan. 11, 2010.

(51) Int. Cl. H01M 4/58; C01B 25/45

(52) U.S. Cl. 252/182.1; 423/306

(57) ABSTRACT

A LiMPO₄-based composition of matter suitable for use to form cathodes to form high-performance Li-based batteries is disclosed. The composition of matter is defined by the formula LiMPO₄, where M is at least one transition metal, and wherein the composition of matter has a general lattice structure. The composition of matter includes Ru ions that substitute for at least one of Li ions and at least one of the ions of the at least one transition metal M. Methods of forming the composition of matter are also disclosed.

### CLAIM OF PRIORITY

This Application claims priority from U.S. Provisional Patent Application Serial No. 61/335,688,entitled “Modified LiFePO₄ cathode materials with ultrafast charge rate and ultrahigh power density for high performance Li Batteries,” filed on Jan. 11, 2010.

### FIELD

The invention relates to Li-based batteries, and in particular relates to LiMPO₄-based compositions of matter for cathodes for high-performance batteries such as Li rechargeable batteries, where M is at least one transition metal.

### BACKGROUND ART

Li rechargeable batteries are presently the most promising candidates for large-scale energy storage applications such as for the next generation of electric and hybrid electric vehicles, electronic devices and other high performance tools, machines, etc. Among the various types of Li rechargeable batteries, olivine-structured LiFePO₄ or LiMPO₄ in general where M can be a transition metal or transition metals, is one of the most promising cathode materials in the electric vehicles due to its high capacity and structural stability (safety). However, its low intrinsic electronic conductivity of 10⁻⁹S/cm prevents the full use of this material to its theoretical capacity. Furthermore, the Li⁺ ion diffusion coefficient is very low, i.e., 10⁻¹¹ to 10⁻¹⁰ cm²S⁻¹.

These two intrinsic drawbacks of olivine-structured LiMPO₄ are a bottleneck for its use in commercial applications. In addition, the reversible capacity loss at high current densities is another shortcoming of LiMPO₄ such as LiFePO₄ and LiMnPO₄ etc. The poor performance at high current densities is believed to be directly associated with the polarization caused by low intrinsic electronic and ionic conductivity. There have been many attempts to modify LiFePO₄, including doping different elements into LiFePO₄, but these attempts have not overcome the aforementioned shortcomings to achieve a LiFePO₄-based cathode with good performance at high charge and discharge current densities.

### SUMMARY

An aspect of the invention provides a method of enhancing the conductivity of lithium metal phosphate materials modified through doping with ruthenium.

Another aspect of the invention is a composition of matter that comprises a material defined by a general formula LiMPO₄, where M is at least one transition metal (e.g., Fe, Mn, Ni and Co), and wherein the material has a general lattice structure. The material further includes Ru ions that substitute for at least one of Li ions and ions of the at least one transition metal M in the general lattice structure.

An example material (compositions of matter) has the general formula Li_{1-αx}RuₓMPO₄ where α is constant and equal to the valence of Ru in stoichiometric form, and is not equal the valence of Ru in nonstoichiometric form, and 0<x<1/α. In an example, the parameter α is equal to the valence of Ru, which can be from 2+ to 8+ (i.e., 2≦α≦8).

Another example material is a lithium manganese phosphate material that uses manganese (Mn) as the transition metal and has the general formula LiMn_{1-αx/2}RuₓPO₄ where α is constant and equal to the valence of Ru ions in the stoichiometric form, and is not equal to the valence of Ru ions in nonstoichiometric form, and 0<x<1/α. In another example, the parameter α is equal to the valence of the Ru ions, which can be from 2+ to 8+. The lithium manganese phosphate material has applications as an active cathode material in Li-ion rechargeable batteries.

Thus, another aspect of the invention is a composition of matter having a general formula of Li_{1-αx}RuₓMPO₄ or LiRuₓM_{1-αx/c}PO₄, where α is equal to the valence of Ru ions, M is at least one transition metal, and c is a valence of M.

Another aspect of the invention is a composition of matter comprising a lithium metal phosphate material system having a general formula of Li₁₋ₐₓRuₓMPO₄ or LiRuₓM_{1-αx/c}PO₄ where α is not equal to the valence of the Ru ions, and c is the valence of M.

Another aspect of the invention is composition of matter that comprises a lithium metal phosphate material system having either a first formula Li_{1-αx}RuₓMPO₄ or a second formula LiRuₓM_{1-αx/c}PO₄. The parameter α is a constant and is not equal to a valence of Ru ions for the first formula and is not equal to a valence of Ru ions for the second formula, x is defined by 0<x<1, M is at least one transition metal, and c is a valence of the at least one transition metal M. In an example, the parameter α is in the range from 1 to 8 for the first formula and is in the range from c to 8 for the second formula.

Another aspect of the invention is a method of synthesizing a composition of matter based on a lithium metal phosphate material. The method includes mixing a lithium compound, a metal compound, a phosphorous compound, and a Ru compound to form a mixture. The method also includes pre-calcining and firing the mixture to form the composition of matter defined by the formula LiMPO₄, where M is at least one transition metal, The composition of matter has a general lattice structure and Ru ions substitute for at least one of the Li ions and M in the general lattice structure.

### BRIEF DESCRIPTION OF THE DRAWINGS

FIG. 1A and FIG. 1B are X-ray diffraction (XRD) spectra (Intensity vs. θ/2θ) of an example lithium iron phosphate material and pure LiFePO₄ (FIG. 1A) and Li₁₋₄ₓRuₓFePO₄ (FIG. 1B), where the lithium iron phosphate material Li₁₋₄ₓRuₓFePO₄ was synthesized according to methods of the invention as described in the Example below, with the spectra of FIG. 1B showing a typical olivine structure without any Ru-based impurity phases;

FIG. 2A and FIG. 2B are scanning electron microscope (SEM) images of pure LiFePO₄ (FIG. 2A) and Li₁₋₄ₓRuₓFePO₄ (FIG. 2B), where the particles of the material are agglomerated and have a particle size ranging from about 100 nm to a few hundred nanometers;

FIG. 3 is a plot of specific capacity (mAh/g) versus voltage (V) for an electrode formed from Li₁₋₄ₓRuₓFePO₄, where the half cell is first charged at a current density of 16 mA/g (0.1 C) to 4.3V without holding, and once the half cell is charged to 4.3V, it is immediately discharged to 2.2V at various current densities ranging from 0.2 C to 30 C (4800 mA/g);

FIG. 4A is a plot similar to FIG. 3 and plots voltage versus charge and discharge capacity profiles for a Li₁₋₄ₓRuₓFePO₄ electrode charged and discharged at different rates varying from 0.05 to 30 C;

FIG. 4B plots the specific capacity (mAh/g) vs. the number of charge/discharge cycles for a Li₁₋₄ₓRuₓFePO₄ electrode, where the electrode is cycled between 2.2V and 4.3V and the charge and discharge rate (current) varies from 1 C to 20 C;

FIG. 5 is a plot similar to FIG. 3 and illustrates charge rate capacities of a Li₁₋₄ₓRuₓFePO₄ electrode charged at charge rates varying from 0.2 to 30 C after fully discharged to 2.0V at a discharge rate of 0.1 C;

FIG. 6 is a plot similar to FIG. 4B for a Li₁₋₄ₓRuₓFePO₄ electrode, and illustrates the durability of electrode as it is cycled at a charge and discharge rate of 20 C.

FIG. 7 shows X-ray diffraction (XRD) spectra (Intensity vs. θ/2θ) of an example lithium manganese phosphate materials of pure LiMnPO₄ and LiMn₁₋₂ₓRuₓPO₄ (x=0.01, 0.02, 0.05);

FIG. 8 is the X-ray diffraction (XRD) spectra of FIG. 7 fine-scanned from 24 degrees to 30 degrees and shows a shift of diffraction peaks from doping with Ru;

FIG. 9A is scanning electron microscope (SEM) image of pure LiMnPO₄ and FIG. 9B is a SEM image of LiMn_{0.98}Ru_{0.01}FePO₄, where the particles of the material are agglomerated and have a particle size ranging from about 200 nm to a few hundred nanometers;

FIG. 10 illustrates charge and discharge profiles of a pure LiMnPO₄ and a LiMn_{0.98}Ru_{0.01}PO₄ electrode showing improved capacity delivery of Ru-doped electrode, wherein the electrodes were first charged at a current density of 10 mA/g to 4.6 V and then held at 4.6 V until the current density decayed to 2 mA/g; and

FIG. 11 illustrates cyclabilities of pure LiMnPO₄ and LiMn_{0.98}Ru_{0.01}PO₄ electrodes at a current density of 10 mA/g.

### DETAILED DESCRIPTION

The invention relates generally to Li-based batteries, and in particular relates to Li rechargeable batteries. Aspects of the invention are directed to the use of ruthenium-doped olivine-structured LiMPO₄ fine powders as active cathode materials for Li-ion and Li rechargeable batteries, where M is at least one transition metal such as Fe, Mn, Ni and Co. Aspects of the invention include methods for greatly enhancing the electrochemical performance of the cathode material at high current densities to achieve high-performance Li rechargeable batteries.

An aspect of the invention includes lithium metal phosphate materials for forming Li-battery cathodes. In an example, the lithium iron phosphate materials have a general lattice structure with an olivine structure (i.e., comprises a modified olivine-structured LiFePO₄) formed via doping with trace amounts of ruthenium (Ru). In another example, the lithium metal phosphate material is in the form of a lithium manganese phosphate material that has a general lattice structure with an olivine structure (i.e., comprises a modified olivine-structured LiMnPO₄) formed via doping with trace amounts of ruthenium. In both examples, the general lattice structures remain unchanged even thought Ru ions occupy lattice sites in the structure via doping.

An example composition of matter disclosed herein comprises a lithium metal phosphate material defined by a general formula LiMPO₄, where M is at least one transition metal (e.g., Fe, Mn, Ni and Co), and wherein the material has a general lattice structure. The material further includes Ru ions that substitute for at least one of Li ions and ions of the at least one transition metal M in the general lattice structure.

Another example composition of matter comprises a lithium metal phosphate material system having either a first formula Li_{1-αx}RuₓMPO₄ or a second formula LiRuₓM_{1-αx/c}PO₄. The parameter α is a constant and is not equal to a valence of Ru ions for the first formula and is not equal to a valence of Ru ions for the second formula, x is defined by 0<x<1, M is at least one transition metal, and c is a valence of the at least one transition metal M. In an example, the parameter α is in the range from 1 to 8 for the first formula and is in the range from c to 8 for the second formula.

Thus, in an example, the lithium metal phosphate material can be in stoichiometric form (i.e, represented by a first formula) when α is equal to the valance of Ru ions or a nonstoichiometric form (i.e., represented by a second formula) when α is not equal to the valance of Ru ions, namely:

Li_{1-αx}RuₓMPO₄ and LiM_{1-αx/c}RuₓPO₄ (0<x<1/α)

where α is constant and is greater than 0, and c is the valence of M, where M is at least one transition metal. In an example, the parameter α is an integer and is equal to the valence of Ru, which can be from 2+ to 8+ (i.e., a can range from 2 to 8). In other examples, the parameter α is not equal to the Ru valence. The Ru-doped lithium metal phosphate material has a general lattice structure that is charge-neutral. In an example of Li_{1-αx}RuₓFePO₄, charge neutrality is maintained via the relationship:

0=(1_{Li}_{¹⁺}−αx·1_{Li}_{¹⁺})+xα_{Ru}_{^{α+}}+2_{Fe}_{²⁺}+5_{P}_{⁵⁺}+4×2_{O}_{²⁺}

Due to the presence of Ru with a high oxidation state, vacancies form in the general lattice structure. The amount (number) of defects in the general lattice structure depends on both the oxidation state and the amount of Ru used. In the nonstoichiometric form, electronic defects are present.

In an example, the Ru ions are substituted for Li ions in the general lattice structure via Ru doping, with the general lattice structure having same number of lattice positions and remaining unchanged relative to undoped lithium iron phosphate general lattice structure.

In another example, the Ru ions are substituted for ions of the at least one transition metal in the lattice structure via Ru doping, with the general lattice structure having same number of lattice positions and remaining unchanged relative to the undoped lithium iron phosphate general lattice structure.

When used as a cathode in a Li battery, the lithium metal phosphate material provides enhanced electrochemical performance at high charge and discharge current density without substantially compromising the battery capacity.

An example method of synthesizing the lithium metal phosphate material includes mixing compounds or elemental Ru with other raw materials by mixing, ball milling, co-precipitation, mechanical activation, mechanical alloying, sol-gel or other mixing methods, wherein the mixing methods generally form a homogeneous mixture. Here, the term “mixing” is generally used to include any one of the above mixing methods or combinations thereof.

The method also includes calcining and firing the mixture for a sufficient time and temperature in a furnace or furnaces having an inner or reductive atmosphere or vacuum protection to achieve homogeneous reaction of the mixture.

Precursors with compounds of Li, M, P, and Ru sources are initially mixed to achieve a certain degree of homogeneity. In an example, the precursors is mixed into acetone, ethanol or distilled water and then ball milled at different energies for 0.5 to 200 hours. In producing the particular lithium iron phosphate material, the mixed powder can be pre-calcined directly or the mixed powder can be further compacted into pellets that are then pre-calcined at temperatures in the range from 200 to 600° C. for a time duration from 30 min to 1440 min or longer.

Example lithium compounds include Li₂CO₃, Li₂O and LiOH. Example iron compounds include FeO, FeC₂O₄, FeC₂O₄.2H₂O, Fe₂O₃ and Fe(AC)₂. Example phosphorous compounds include NH₄H₂PO₄, (NH₄)₂HPO₄, (NH₄)₃PO₄, P₂O₅, H₃PO₄. Example of manganese compounds include Mn(CH₃COO)₂, MnO, etc. Example ruthenium compounds include RuO₂ and RuCl₃.

After pre-calcining, the mixed powder can be fired with a fire temperature ranging from 500 to 1000° C. for a time duration from about 30 minutes to about 6000 minutes or longer. Alternatively, the calcined powder or calcined pellets is/are ball milled, or ground or treated by other means to achieve a fine powder having a substantially homogenous chemical and size distribution before firing at the aforementioned temperature and time duration ranges. In an example, the calcining and the firing of the mixed powder can be performed with intermittent grinding. In an example, the firing temperature can be maintained substantially constant over the firing time duration.

In an example, an amount of carbon can be mixed into the precursor during the regrinding process to enhance the conductivity and electrochemical properties of the final lithium iron phosphate material. The properties and quality of the final lithium iron phosphate material may be altered by changing one or more of the process parameters, such as the firing temperature, the firing duration, the heating and cooling rates, etc. As such, the various synthesis parameters can be controlled in manners understood by one skilled in the art in order to achieve desirable properties and performance of the lithium iron phosphate material.

### EXAMPLE 1

### Li₁₋₄ₓRuₓFePO₄

An example embodiment of the lithium iron phosphate material has a Ru valence of 4 (i.e., α=4, the valence of Ru⁴⁺ used here), so that the formula for the lithium iron phosphate material is Li₁₋₄ₓRuₓFePO₄. Based on this formula, the content of Ru can be varied from x=0.0001 mole to a maximum 0.2500 mole.

To synthesis the example lithium iron phosphate material, stoichiometric amounts of Li₂CO₃, FeC₂O₄.2H₂O, NH₄H₂PO₄ and RuO₂ are mixed according to corresponding formula in an acetone liquid, ethanol, or distilled water and then ball-milled for a few hours to form a homogeneous mixture using a low-energy horizontal mill.

After ball milling, a firing step is carried out, which in an example is a two-step solid-state reaction carried out at 350° C. and 600° C., respectively, in a furnace with flowing argon. Intermittent mixing and grinding are performed to ensure chemical homogeneity in the resultant active powder.

After the firing step, the active powder is well mixed with 15% carbon black powder and 5% polyvinylidene fluoride (PVDF) to form a slurry. The slurry is cast on to an aluminium foil to form an electrode. In the electrochemical test, metal Li is used as an anode as well as the reference electrode.

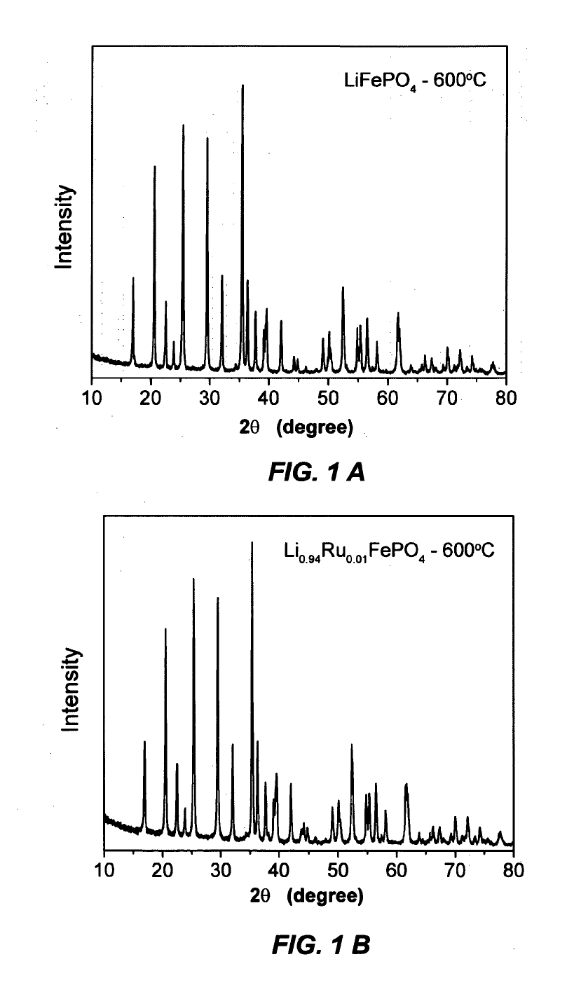

FIG. 1A and FIG. 1B are X-ray diffraction (XRD) spectra of an example lithium iron phosphate material pure LiFePO₄ (FIG. 1A) and Li₁₋₄ₓRuₓFePO₄ (FIG. 1B). The lithium iron phosphate material Li₁₋₄ₓRuₓFePO₄ was synthesized according to the methods described herein, with the spectra of FIG. 1B showing a typical olivine structure without any impurity phases associated with Ru. Thus, the fact that the two spectra are essentially identical indicates that the general lattice structures for the two materials are essentially identical and for all intents and purpose are considered to be the same.

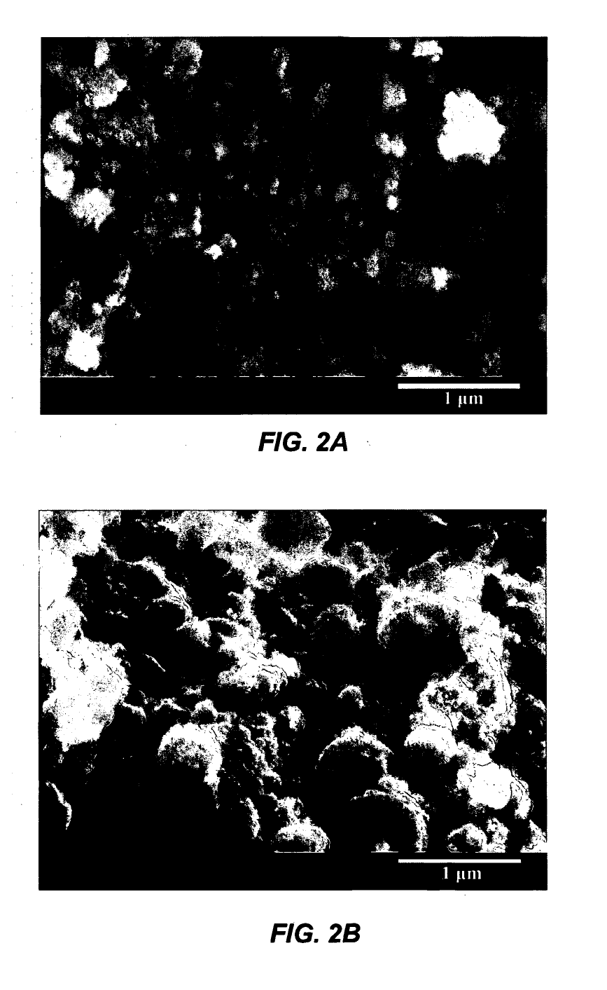

FIG. 2A and FIG. 2B are the scanning electron microscopy images of pure LiFePO₄ (FIG. 2A) and Li₁₋₄ₓRuₓFePO₄ (FIG. 2B) that illustrate the morphologies of these materials. The particles are agglomerated and have a particle size ranging from about 100 nm to a few hundred nanometers.

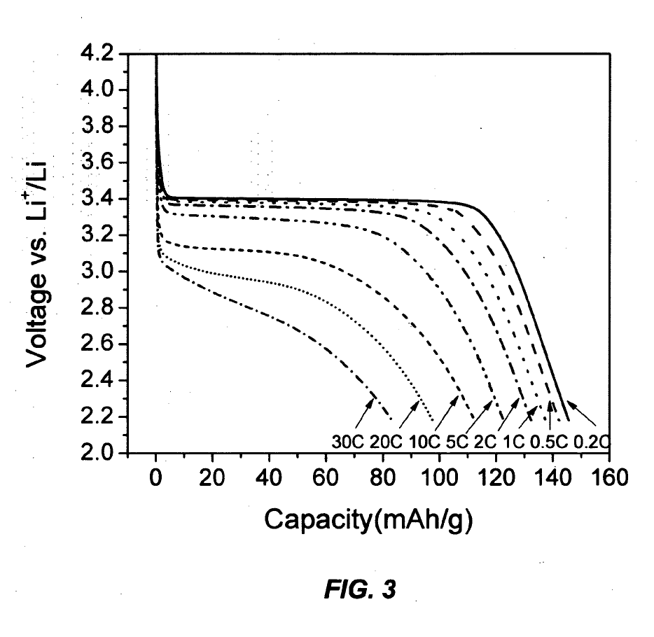

FIG. 3 is a plot of the specific capacity (mAh/g) versus voltage, and shows the discharge capability of the Li₁₋₄ₓRuₓFePO₄ electrode for various discharge rates. A lithium foil was used as an anode as well as a reference, and a half cell was first charged at a current density of 16 mA/g (0.1 C) to 4.3V without holding at 4.3V. Once the half cell was charged to 4.3V, it was immediately discharged to 2.2V at various current densities ranging from 0.2 C to 30 C (4800 mA/g). It can be seen from the plot that even at the charge rate as high as 20 C, the cathode can still deliver a capacity of 97 C mAh/g.

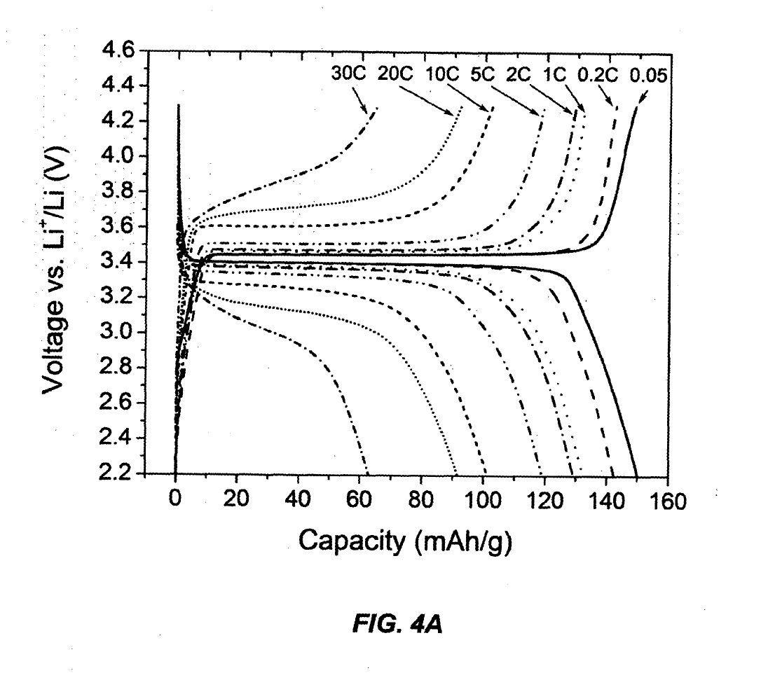

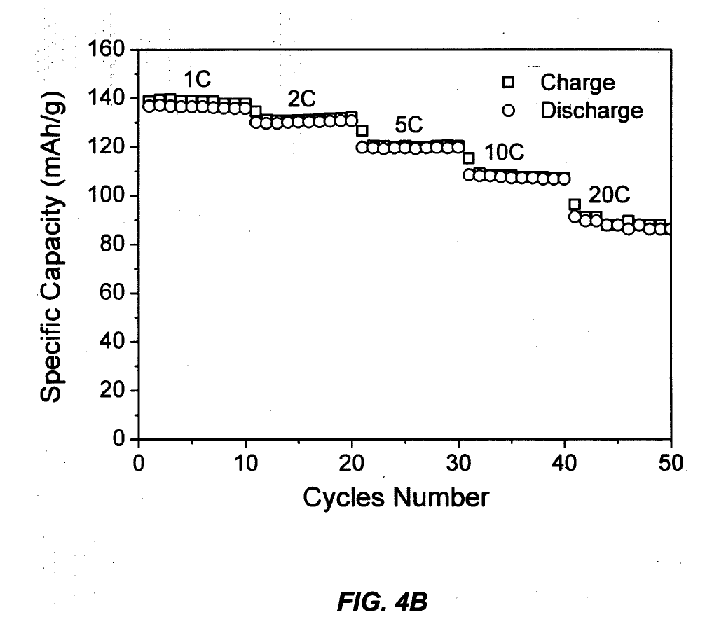

FIG. 4A is a plot similar to FIG. 3 and illustrates voltage versus discharge capacity profiles for a Li₁₋₄ₓRuₓFePO₄ electrode charged and discharged at the same rate varying from 0.05 to 30 C. At a low charge and discharge rate of 0.05 C, a discharge capacity of 150 mAh/g can be obtained, while 92 and 63 mAh/g can be achieved for the high charge/discharge rate 20 C and 30 C, respectively. Compared with the results obtained in FIG. 3, where the electrode is charged at 0.1 C, it can be seen that in both cases, the discharge capacity is about the same.

FIG. 4B plots the specific capacity (mAh/g) vs. the number of charge/discharge cycles for the Li₁₋₄ₓRuₓFePO₄ electrode, where the electrode is cycled between 2.2V and 4.3V at rate (current) varying from 1 C to 20 C.

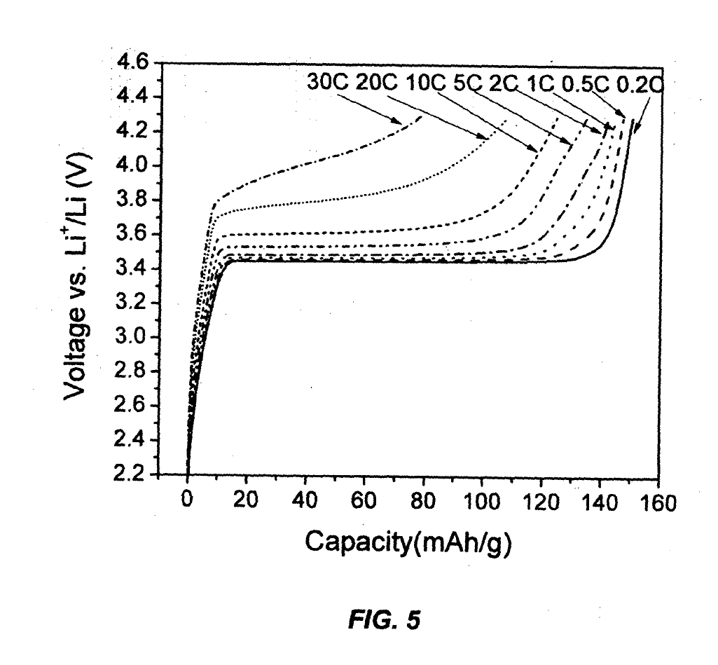

FIG. 5 is a plot similar to FIG. 3 and illustrates charge capacities of a Li₁₋₄ₓRuₓFePO₄ electrode charged and discharged at different rates varying from 0.1 to 30 C. The charge capacity of the Li₁₋₄ₓRuₓFePO₄ was measured at the different charge rates after being fully discharged to 2.0V at a discharge rate of 0.1 C. It can be seen from the plot of FIG. 5 that the Li₁₋₄ₓRuₓFePO₄ electrode can be charged to 4.3V from 2.2V at 4800 mA/g (30 C) in about 4 min with still more than 70% of the theoretical capacity. At a low charge rate of 0.2 C, a high charge capacity of 150 mAh/g was obtained. With an increase in the charge rate, there is only slight decrease in the charge capacity when the charge rate is below 20 C. At a charge rate of 20 C, a charge capacity as high as 107 mAh/g can be achieved.

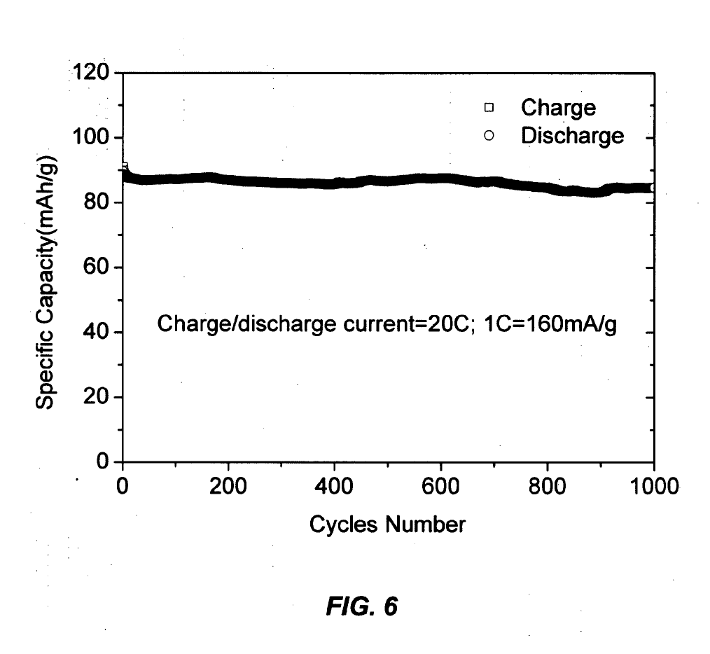

The Li₁₋₄ₓRuₓFePO₄ cathode material also shows excellent cycability at high charge/discharge current density. As shown in FIG. 6, the Li₁₋₄ₓRuₓFePO₄ cathode electrode is cycled 1000 times at a high current density of 3200 mA/g without a substantial fade in charge capacity. The initial charge capacity is about 88 mAh/g and there is almost no charge capacity fade after 1000 cycles at room temperature of 25° C.

### EXAMPLE 2

### LiMn₁₋₂ₓRuₓPO₄

Another example material is LiMnPO₄, where Ru is doped in the transition metal lattice (i.e. Mn lattice position) forming LiMn₁₋₂ₓRuₓPO₄. Based on this formula, the content of Ru can be varied from x=0.0001 mole to a maximum of 0.5000 mole.

To synthesize the example lithium manganese phosphate material, stoichiometric amounts of CH₃COOLi.2H₂O, Mn(CH₃COO)₂.4H₂O, NH₄H₂PO₄ and RuO₂ are mixed according to corresponding formula in an acetone liquid, ethanol, or distilled water and then ball-milled for a few hours to form a homogeneous mixture.

After ball milling, a firing step is carried out, which in an example is a two-step solid state reaction carried out at 350° C. and 600° C., respectively, in a furnace with flowing argon. Intermittent mixing and grinding are performed to ensure chemical homogeneity in the resultant active powder.

After the firing step, the active powder is well mixed with 20% carbon black powder and 10% polyvinylidene fluoride (PVDF) to form a slurry. The slurry is cast on to an aluminium foil to form an electrode. In the electrochemical test, metal Li is used as an anode as well as the reference electrode.

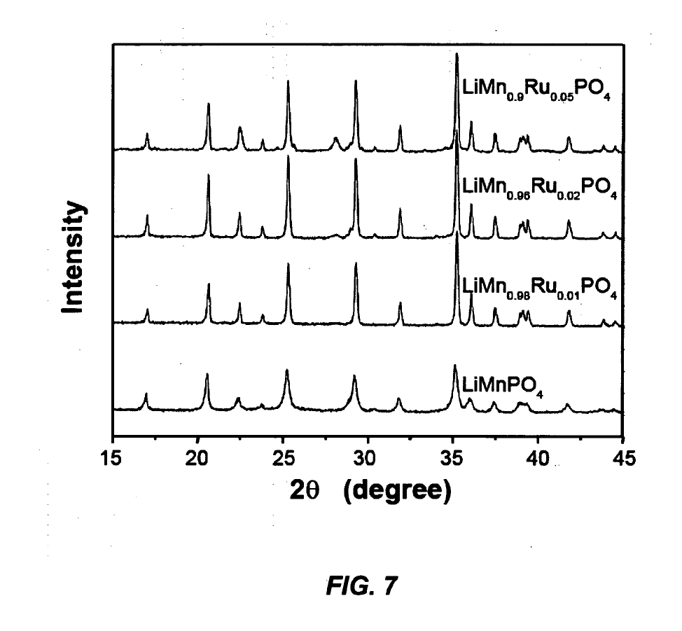

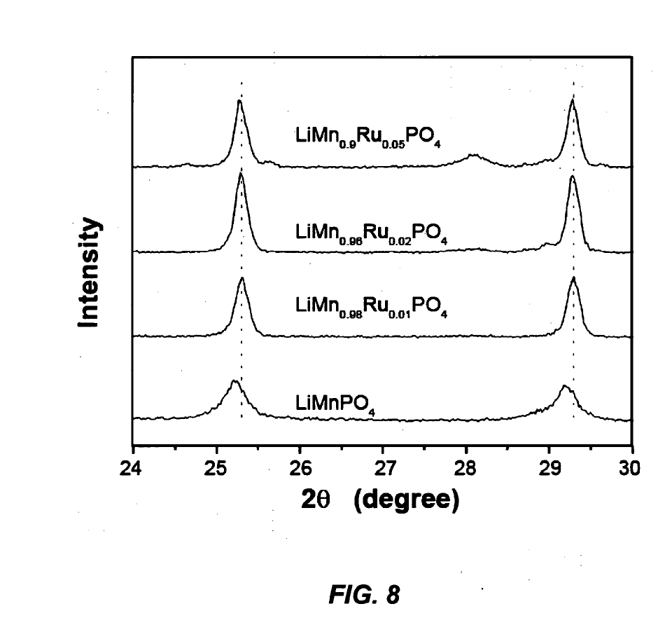

FIG. 7 shows X-ray diffraction (XRD) spectra of the pure LiMnPO₄ and LiMn₁₋₂ₓRuₓPO₄ (x=0.01, 0.02, 0.05). FIG. 8 reveals the detailed X-ray diffraction spectra fine-scanned from 24 to 30 degrees. It can be seen that XRD diffraction peaks of LiMn₁₋₂ₓRuₓPO₄ are shifted to a high angle.

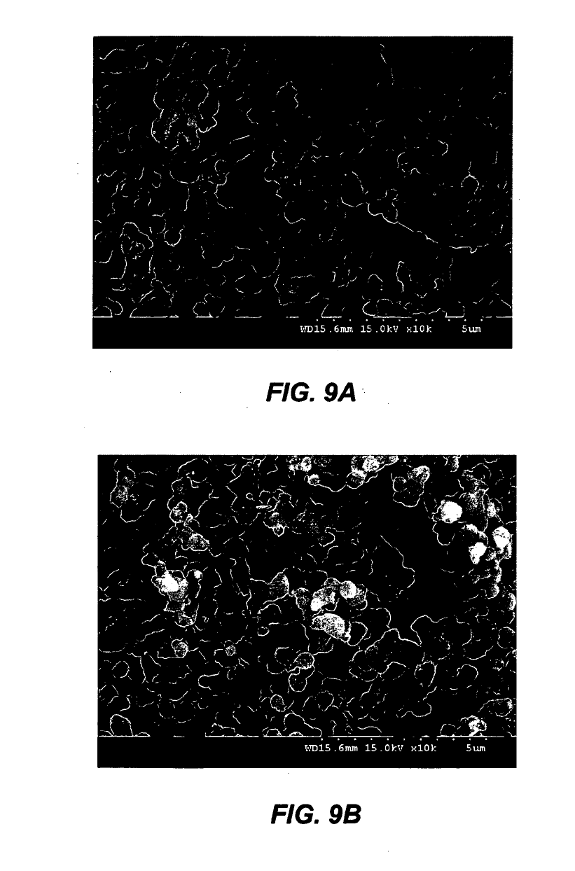

FIG. 9 is scanning electron microscope (SEM) images of pure LiMnPO₄ (FIG. 9A) and LiMn_{0.98}Ru_{0.01}FePO₄ (FIG. 9B), where the size of the particles of the material is about 200 nm to a few hundred nanometers and they are agglomerated.

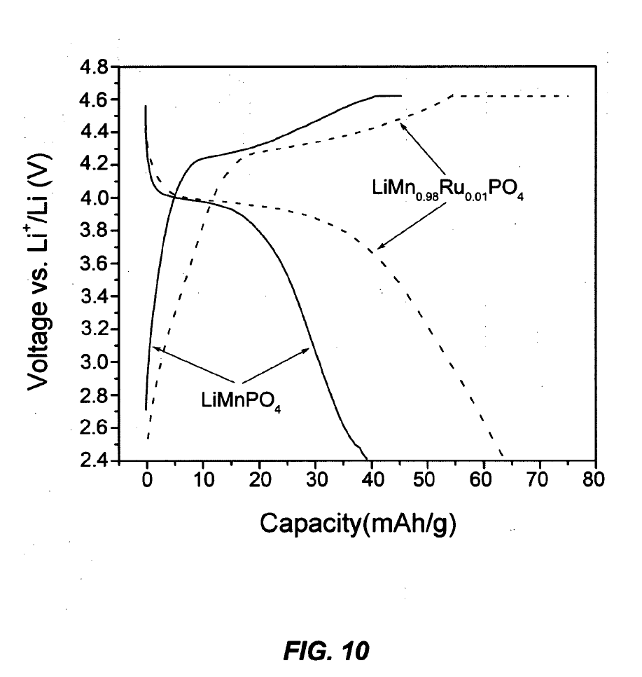

FIG. 10 illustrates charge and discharge piofiles of the pure LiMnPO₄ and LiMn_{0.98}Ru_{0.01}PO₄ electrodes. The electrodes are first charged to 4.6 V at a current density of 10 mA/g and then held at 4.6 V until the current density decays to 2 mA/g. The Ru doped material clearly shows improved capacity.

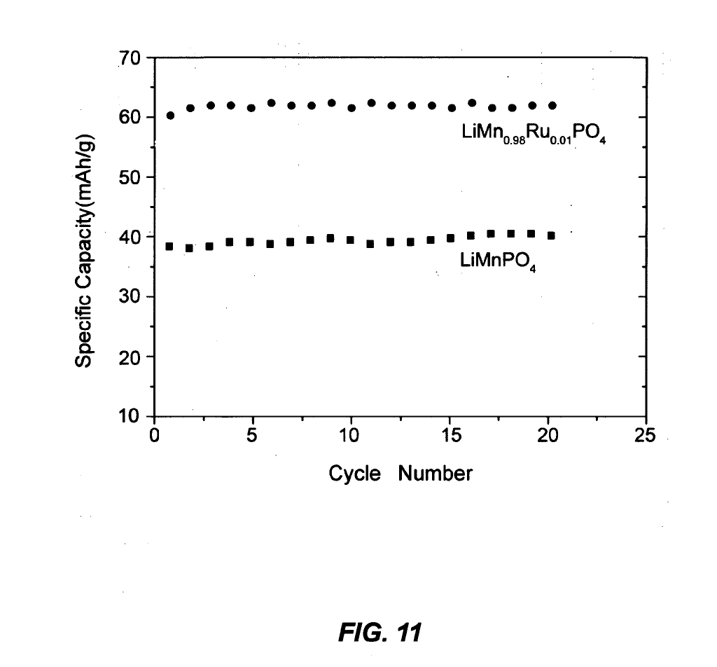

FIG. 11 illustrates cyclabilities of the pure LiMnPO₄ and LiMn_{0.98}Ru_{0.01}PO₄ electrodes at a current density of 10 mA/g.

What is claimed is:

1. A composition of matter, comprising:
a material defined by a general formula LiMPO₄, where M is at least one transition metal, and wherein the material has a general lattice structure; and
wherein the material further includes Ru ions that substitute for at least one of Li ions and ions of the at least one transition metal M in the general lattice structure.

2. A composition of matter according to claim 1, wherein the composition of matter is further defined by a first formula Li_{1-αx}RuₓMPO₄ or a second formula LiM_{1-αx/c}RuₓPO₄, where α is a constant and is equal to a valence of Ru ions for the first formula or is equal to a valence of Ru ions for the second formula, x is defined 0<x<1/α, and c is a valence of the at least one transition metal M.

3. The composition of matter of clam 2, wherein α is in the range from 2 to 8.

4. The composition of matter of claim 1, further comprising the general lattice structure with the Ru ions having the same number of lattice positions as the general lattice structure without Ru ions.

5. The composition of matter of claim 1, wherein the general lattice structure remains unchanged upon the introduction of the Ru ions.

6. The composition of matter of claim 1, wherein the general lattice structure that includes the Ru ions comprises an olivine structure.

7. The composition of matter of claim 1, wherein the general lattice structure that includes the Ru ions is charge neutral.

8. The composition of matter of claim 1, further comprising the Ru ions creating lattice defects in the general lattice structure.

9. A composition of matter comprising:
a lithium metal phosphate material system having either a first formula Li_{1-αx}RuₓMPO₄ or a second formula LiRuₓM_{1-ax/c}PO₄; and
where α is a constant and is not equal to a valence of Ru ions for the first formula and is not equal to a valence of Ru ions for the second formula, x is defined by 0<x<1, M is at least one transition metal, and c is a valence of the at least one transition metal M.

10. The composition of matter of claim 9, wherein α is in the range from 1 to 8 for the first formula Li_{1-αx}RuₓMPO₄, and α is in the range from c to 8 for the second formula LiRuₓM_{1-αx/c}PO₄;

11. The composition of matter of claim 9, wherein the Ru ions partly substitute for Li ions.

12. The composition of matter of claim 9, wherein the Ru ions partly substitute for ions of the at least one transition metal M.

13. The composition of matter of claim 9, wherein the Ru ions partly substitute for Li ions and partly substitute for ions of the at least one transition metal.

14. The composition of matter of claim 9 having a general lattice structure with a same number of lattice positions as undoped lithium metal phosphate.

15. The composition of matter of claim 14, wherein the general lattice structure remains unchanged after Ru doping.

16. The composition of matter of claim 14, wherein the general lattice structure comprises an olivine structure.

17. The composition of matter of claim 9, wherein the Ru ions create lattice defects and electronic defects in the material system.

18. A method of synthesizing a lithium metal phosphate composition of matter, comprising:
mixing at least one lithium compound, at least one transition metal compound, at least one phosphorous compound, and at least one Ru compound to form a mixture; and
pre-calcining and firing the mixture to form said composition of matter defined by the formula LiMPO₄, where M is at least one transition metal, and wherein the composition of matter has a general lattice structure, and wherein Ru ions substitute for at least one of Li and M in the general lattice structure.

19. The method according to claim 18, comprising at least one of the following:
a) selecting the at least one lithium compound from a group of lithium compounds consisting of Li₂CO₃, Li₂O, LiCH₃COO.2H₂O, LiH₂PO₄, LiOH;
b) selecting the at least one iron compound from a group of iron compounds consisting of: MO, MC₂O₄, MC₂O₄.2H₂O, M₂O₃, MCO₃ and Fe(Ac)₂ (M=Fe, Mn, Ni, Co); and
c) selecting the at least one phosphorous compound from a group of phosphorous compounds consisting of: NH₄H₂PO₄, (NH₄)₂HPO₄, (NH₄)₃PO₄, P₂O₅, LiH₂PO₄, H₃PO₄.

20. The method according to claim 19, further comprising performing intermittent grinding during the calcining and the firing.

21. The method according to claim 19, further comprising forming the mixture to be in either a powder form or a pellet form.

22. The method according to claim 19, further comprising performing the pre-calcining to have a temperature in a range from approximately 200° C. to approximately 600° C., and for a time duration in the range from approximately 30 minutes to approximately 1440 minutes.

23. The method according to claim 19, further comprising maintaining the pre-calcining temperature over the time duration.

24. The method according to claim 19, further comprising:
performing the firing to have a temperature range from approximately 500° C. to approximately 1000° C., and for a time duration in the range of approximately 30 minutes to approximately 6000 min; and
performing a grinding process during the firing temperature time duration.

25. The method according to claim 19, further comprising maintaining the firing temperature over the firing process time duration.
